(19) United States
(12) Patent Application Publication
(10) Pub. No.: US 2006/0066820 A1
(43) Pub. Date: Mar. 30, 2006

(54) Reflection-type light modulation array device and image forming apparatus

(75) Inventor: Koichi Kimura, Kanagawa (JP)

Correspondence Address: SUGHRUE MION, PLLC, 2100 PENNSYLVANIA AVENUE, N.W., SUITE 800, WASHINGTON, DC, 20037, US

(73) Assignee: FUJI PHOTO FILM CO., LTD.

(21) Appl. No.: 11/239,203

(22) Filed: Sep. 30, 2005

(30) Foreign Application Priority Data
Sep. 30, 2004 (JP) P2004-287801

(51) Int. Cl. G03B 21/28

(52) U.S. Cl. 353/99

(57) ABSTRACT

A reflection-type light modulation array device, including: a plurality of light modulation devices arranged in a array form, each of which includes a displaceable light reflecting member capable of having an ON state in which incident light is allowed to emerge to an image formation surface and an OFF state in which incident light is not allowed to emerge to the image formation surface, and light modulation is performed by individually controlling displacements of the light reflecting members; a substrate on which the plurality of light modulation devices are arranged in an array form; and a transparent member arranged to be opposite to the substrate through a gap, wherein the transparent member includes, at a position opposite to at least a part of an area of a gap between effective areas where the light modulation is performed on the substrate when viewed on a plane, a light shielding unit to prevent the incident light from entering the substrate.

This application is based on Japanese Patent application JP 2004-287801, filed Sep. 30, 2004, the entire content of which is hereby incorporated by reference. This claim for priority benefit is being filed concurrently with the filing of this application.

### BACKGROUND OF THE INVENTION

1. Technical Field of the Invention

The present invention relates to a reflection-type light modulation array device including plural light modulation devices arrayed in a array form, each of which includes a displaceable light reflecting member capable of having an ON state in which incident light is allowed to emerge to an image formation surface and an OFF state in which incident light is not allowed to emerge to the image formation surface, and the displacements of the light reflecting members are individually controlled so that light modulation is performed.

2. Description of the Related Art

A light modulation array device is used for various image forming apparatuses (for example, an on-demand digital exposure apparatus used for a photolithography process, a printing apparatus for performing printing by digital exposure, a projector, a micro-display apparatus such as a head-mount display, etc.).

The light modulation array device is the device in which light modulation devices each having a light modulation function are arranged on a substrate in an array form (without distinction of one dimension and two dimension), and the operations of the respective light modulation devices are individually controlled so that a light modulation effect is exhibited. As the light modulation array device, there are known a liquid crystal device, a device using electrooptic crystal, a device using magnetooptic crystal, and a device using a micro-electro-mechanical component by a MEMS (Micro-Electro-Mechanical-Systems) technique.

In these devices, especially the device (hereinafter sometimes simply referred to as the MEMS or MEMS device) using the micro-electro-mechanical component by the MEMS technique is excellent in high speed, high integration, and wavelength selectivity (degree of freedom of wavelength selection for wavelengths from a UV wavelength to an infrared wavelength), and in recent years, various devices have been developed.

As the light modulation array device of the MEMS system, there is known a spatial light modulation array device (SLM) typified by a DMD (registered trademark), a GLV (registered trademark) or the like. These are reflection-type light modulation array devices (hereinafter referred to as the reflection-type light modulation array device), and the device includes plural light modulation devices arranged in an array form and each including a displaceable light reflecting member (mirror or the like) capable of having an ON state in which incident light is allowed to emerge to an image formation surface (a recording material surface in the case of an exposure apparatus, a screen in the case of a projector, or the like) and an OFF state in which incident light is not allowed to emerge to the image formation surface, and performs light modulation by individually controlling the displacements of the light reflecting members. In the reflection-type light modulation array device, a drive circuit to control the displacement of the light reflecting member can be provided below the light reflecting member, and high integration can be achieved.

In the reflection-type light modulation array device, when incident light enters a gap area between light modulation devices on a silicon substrate (an area where incident light can not be used for modulation: an area between adjacent mirrors in the case of the DMD, an area other than a beam area where diffraction is correctly performed in the case of the GLV), there arise problems as described below.

(1) Since light incident on the gap area becomes stray light or unnecessary light, the optical quality of the system is degraded (reduction in contrast, or the like).

(2) The surface of the silicon substrate is degraded by a photochemical reaction or the like, or the drive circuit provided on the silicon substrate is erroneously operated.

(3) The incident light is absorbed by the silicon substrate or the like, so that the optical energy is converted into heat to generate heat, and the performance of a semiconductor device, a light modulation device and the like formed on the silicon substrate are degraded.

On the other hand, in order to obtain a further high speed response property in the reflection-type light modulation array device, it is effective to decrease the area of the light reflecting member. When the area of the light reflecting member is decreased, merits as described below are obtained.

(1) The weight of the light reflecting member is reduced so that the inertia moment becomes low, and displacement response is improved.

(2) When the area of the light reflecting member is decreased, in the case where the same displacement angle is obtained, the gap length can be made short. That is, even in the case of the same applied voltage, electrostatic force becomes large as compared with one with a large area, and high speed response is obtained.

This point will be specifically described with reference to the drawings.

FIG. 12 is a perspective view showing a structural example of the SLM.

As shown in the drawing, the SLM includes a substrate 1 on which a drive circuit of a semiconductor device and the like is formed, fixed electrodes 2 formed on the substrate 1, support parts 3, a twist hinge (hereinafter sometimes simply referred to as a hinge) 4, and a movable mirror 5.

FIGS. 13A and 13B are sectional views along line XIII-XIII of the SLM of FIG. 12.

As shown in FIG. 13A, in the case where electric field does not act, the movable mirror 5 is in a state where it is parallel to the surface of the substrate 1, and in this case, the incident light from just above is reflected vertically. On the other hand, as shown in FIG. 13B, when electric field acts, the movable mirror is tilted to the left, and the incident light from just above is reflected obliquely upward left. As stated above, modulation of the incident light can be performed by performing the control (deflection control of light) to change the direction of the reflected light.

FIG. 14 is a plan view of a device in which the SLM of FIG. 12 is arranged in a matrix form. In FIG. 14, portions common to FIG. 12 are denoted by the same reference numerals. In FIG. 14, four SLMs in total form a two-dimensional matrix, and each of the SLMs corresponds to one pixel. A square area drawn around the movable mirror 5 is a pixel area 6 corresponding to one pixel.

As is understood from FIG. 14, the pixel area 6 includes an effective area Z1 as an area where modulation of incident light is performed and an ineffective area Z2 as an area where modulation of incident light is not performed. In the pixel area 6, since the movable mirror 5 (corresponding to the effective area Z1) is arranged at the center, the hinge 4 and the support part 3 are arranged at the outside of the movable mirror 5, and the ratio of the effective area Z1 in the pixel area 6 is low. Accordingly, in the case where the pixel area 6 is arranged in an array form, the ratio of the ineffective area Z2 is increased in total.

Here, especially, in order to perform low voltage driving, it is necessary to reduce the deflection elastic modulus of the hinge 4. For that purpose, it is necessary that Young's modulus of the material constituting the hinge 4, the thickness of the hinge 4, and the width thereof are reduced, whereas the length of the hinge 4 is made long. However, there is a limit in the reduction of the Young's modulus of the material constituting the hinge 4, the thickness of the hinge 4, and the width thereof. Accordingly, in the design of the SLM, a method of adjusting the length of the hinge 4, which is easy to realize, is often used. In the case where the length of the hinge 4 is made long, the ineffective area Z2 becomes further large. When the SLM is arranged in the array form, the ratio of the ineffective area Z2 is further increased.

As stated above, when the speed of the reflection-type light modulation array device is increased, the ineffective area is resultantly increased, and the foregoing problems due to the incident light incident on this portion become more noticeable. Accordingly, in the reflection-type light modulation array device, a countermeasure against unnecessary light or a countermeasure against stray light becomes more important.

As proposed related art techniques of the countermeasure against stray light, there are techniques disclosed in, for example, JP-A-2003-098447, JP-A-2001-249290, and JP-A-9-230257(hereafter, referred to “JPA'447”, “JPA'290”, and “JPA'257”, respectively). JPA'447 and JPA'290 disclose a structure in which a light absorbing film is provided on a substrate of a reflection-type light modulation array device. JPA'257 discloses a structure in which in the SLM, a recess is provided in a substrate.

FIG. 15 is a view for explaining the rough outline (point) of the technique disclosed in JPA'447.

As shown in the drawing, a light absorbing film 8 is formed on a silicon substrate 1 at a position which is opposite to an area of a gap between MEMS devices 7, and this light absorbing film 8 absorbs incident light entering the gap, and prevents the light from being reflected to an image formation surface side.

FIG. 16 is a view for explaining the rough outline (point) of the technique disclosed in JPA'257.

As shown in the drawing, a recess 9 is provided on a silicon substrate 1 at a position which is opposite to an area of a gap between MEMS devices 7, and this recess 9 traps incident light entering the gap, and prevents the light from being reflected to an image formation surface side.

In the related art, since the light absorbing film or the recess is provided on the substrate on which the light modulation device (MEMS device) is formed, the manufacturing process becomes complicated. Besides, since the reflection-type light modulation device is a mechanically displaced structure, in the case where the light absorbing film is formed in an area other than this device area, it is necessary that the light absorbing film is made to have a three-dimensional structure, and the process becomes more complicated, and according to circumstances, the reliability of the whole device and the performance are influenced. Besides, in the case where light with a short wavelength and large power, such as ultraviolet light, is used, the substrate generates heat by the incident light, and there is a possibility that a bad influence is exerted on the operation of a semiconductor device formed on the substrate.

### SUMMARY OF THE INVENTION

The invention has been made in view of the above circumstances, and an object of at least one embodiment of the invention is to provide a reflection-type light modulation array device in which a manufacturing process can be simplified, and even in the case where high power light is used, the influence of incident light on a substrate is reduced, and the degradation of a light modulation function can be prevented.

A reflection-type light modulation array device of the invention includes plural light modulation devices arrayed in a array form, each of which includes a displaceable light reflecting member capable of having an ON state in which incident light is allowed to emerge to an image formation surface and an OFF state in which incident light is not allowed to emerge to the image formation surface, and performs light modulation by individually controlling displacements of the light reflecting members, wherein the reflection-type light modulation array device includes a substrate on which the plural light modulation devices are arranged in an array form, and a transparent member arranged to be opposite to the substrate through a gap, and the transparent member includes, at a position opposite to at least a part of an area of a gap between effective areas where the light modulation is performed on the substrate when viewed on a plane, a light shielding unit to prevent the incident light from entering the substrate.

By this structure, since the light-shielding unit is formed on the transparent member, a manufacturing process of the substrate on which the light modulation devices are formed is simplified, and it is possible to prevent incident light unnecessary for light modulation from being incident on the substrate. Thus, even in the case where ultraviolet light or the like is used, heat generation of the substrate is suppressed, and accordingly, characteristic variations of the device and the like do not occur.

In the reflection-type light modulation array device of the invention, the light-shielding unit is preferably provided at the position on a surface of the transparent member at a side of the substrate.

By this structure, since the light-shielding unit is provided on the surface of the transparent member at the substrate side, the area of the gap between the light reflecting members becomes close to the light-shielding unit, and the incident light can be effectively shielded.

In the reflection-type light modulation array device of the invention, the light-shielding unit is preferably provided at the position on a surface opposite to a surface of the transparent member at a side of the substrate or in an inside of the transparent member.

By this structure, since the light-shielding unit is provided on the opposite surface to the surface of the transparent member at the substrate side or in the inside thereof, as compared with the case where the light-shielding unit is provided on the surface, the light-shielding unit becomes remote from the substrate, and the influence on the substrate when the incident light is shielded by the light-shielding unit can be reduced.

In the reflection-type light modulation array device of the invention, the light-shielding unit is preferably provided at the position on a surface of the transparent member at a side of the substrate and an opposite surface thereto.

By this structure, shielding of the incident light can be more effectively performed.

In the reflection-type light modulation array device of the invention, the light modulation device changes preferably a reflection direction of the incident light by the light reflecting member and has the ON state and the OFF state.

In the reflection-type light modulation array device of the invention, the light modulation device preferably includes a hinge part which supports the light reflecting member and can tilt and displace it with respect to the substrate, and a support part to support the hinge part on the substrate, and the reflection direction of the incident light is changed by tilting and displacing the light reflecting member by electrostatic force.

By this structure, since the modulation is performed while the light reflecting member is displaced by the electrostatic force, high speed driving and reduction in consumed electric power are possible, and this is suitable for realization of arrayed structure and high integration.

In the reflection-type light modulation array device of the invention, the light-shielding unit is preferably a reflecting member to reflect the incident light.

By this structure, the incident light is reflected, and it is possible to prevent the incident light from entering the gap area.

In the reflection-type light modulation array device of the invention, a reflection direction of the incident light reflected by the reflecting member is preferably equal to a part of a reflection direction of the incident light when the light reflecting member has the OFF state.

By this structure, since the incident light reflected by the reflecting member is not allowed to emerge to the image formation surface, the S/N of the modulated light can be improved.

In the reflection-type light modulation array device of the invention, the light reflecting member preferably includes one of a metal mirror, a multi-layer interference mirror, and a diffraction grating.

In the reflection-type light modulation array device of the invention, it is preferably that the incident light is light with a wavelength of 450 nm or less, and the light reflecting member is one of a mirror of aluminum or aluminum alloy and a multi-layer interference mirror.

By this structure, even in the case where the light with a wavelength of 450 nm or less is used, the incident light can be effectively reflected, and the influence on the substrate can be made as small as possible.

In the reflection-type light modulation array device of the invention, the light-shielding unit is preferably a light reflecting member to diffuse or scatter the incident light.

By this structure, the incident light is diffused, so that it is possible to prevent the incident light from entering the area of the gap between the effective areas.

In the reflection-type light modulation array device of the invention, the light-shielding unit is preferably an absorbing member to absorb the incident light.

By this structure, the incident light is absorbed, so that it is possible to prevent the incident light from entering the area of the gap between the effective areas.

In the reflection-type light modulation array device of the invention, the light modulation device preferably includes a hinge part which supports the light reflecting member and can vertically displace it, and a support part to support the hinge part on the substrate, and the light reflecting member is vertically displaced to change a phase of the incident light reflected by the light reflecting member and has the ON state and the OFF state.

In the reflection-type light modulation array device of the invention, the light-shielding unit is preferably an absorbing member to absorb the incident light.

By this structure, the incident light is absorbed, so that it is possible to prevent the incident light from entering the area of the gap between the effective areas. Besides, since the reflection direction of the incident light becomes the same between the ON state and the OFF state of the light reflecting member, the S/N of the reflected light subjected to phase modulation can be improved by using the absorbing member instead of using the reflecting member as the light-shielding unit.

In the reflection-type light modulation array device of the invention, the light-shielding unit is preferably a reflecting member to diffuse or scatter the incident light.

By this structure, the incident light is diffused, so that it is possible to prevent the incident light from entering the area of the gap between the effective areas. Besides, since the reflection direction of the incident light becomes the same between the ON state and the OFF state of the light reflecting member, the S/N of the reflected light subjected to phase modulation can be improved by using the reflecting member instead of using the reflecting member as the light-shielding unit.

The reflection-type light modulation array device of the invention preferably includes a support part to support the transparent member on the substrate.

By this structure, the light modulation array device can be formed by bonding the substrate and the transparent member, and effective manufacturing becomes possible.

An image forming apparatus of the invention includes the reflection-type light modulation array device, a light source to make the incident light incident on the reflection-type light modulation array device, and a projection optical system to project light emerging from the reflection-type light modulation array device in the ON state onto an image formation surface.

According to at least one embodiment of the invention, the reflection-type light modulation array device can be provided in which the manufacturing process can be simplified, and even in the case where high power light is used, the influence of the incident light on the substrate is reduced, and the degradation of the light modulation function can be prevented.

### BRIEF DESCRIPTION OF THE DRAWINGS

FIGS. 1A and 1B are views showing a layout structure of a main member of a reflection-type light modulation array device and a sectional structure thereof and for explaining a first embodiment.

FIG. 2 is a sectional view for explaining the operation of the reflection-type light modulation array device of FIGS. 1A and 1B at the time of voltage application and at the time of no voltage application.

FIG. 3 is a sectional view showing an example in which a light diffusing film is used as a light-shielding unit in the reflection-type light modulation array device shown in FIGS. 1A, 1B and 2.

FIGS. 4A to 4C are sectional views showing other examples of a formation position of a light reflecting member.

FIGS. 5A and 5B are views showing a layout structure of a main member of a reflection-type light modulation array device and a sectional structure thereof and for explaining a second embodiment of the invention.

FIG. 6 is a sectional view for explaining the operation of the reflection-type light modulation array device of FIGS. 5A and 5B at the time of voltage application and at the time of no voltage application.

FIGS. 7A and 7B are views showing a layout structure of a main member of a reflection-type light modulation array device and a sectional structure thereof and for explaining a third embodiment of the invention.

FIG. 8 is a sectional view for explaining the operation of the reflection-type light modulation array device of FIGS. 7A and 7B at the time of voltage application and at the time of no voltage application.

FIG. 9 is a sectional view showing an example in which a light diffusing film is used as a light-shielding unit in the reflection-type light modulation array device shown in FIGS. 7A, 7B and 8.

FIGS. 10A to 10E are views for explaining main manufacturing steps of the reflection-type light modulation array device shown in FIGS. 1A and 1B.

FIG. 11 is a view showing a main structure of an example (exposure apparatus) of an image forming apparatus in which the reflection-type light modulation array device explained in the first to the third embodiments is mounted.

FIG. 12 is a perspective view showing a structural example of an SLM.

FIGS. 13A and 13B are sectional views taken along line XIII-XIII of the SLM of FIG. 12.

FIG. 14 is a plan view of a device in which the SLM of FIGS. 13A and 13B is arranged in a matrix form.

FIG. 15 is a view for explaining the rough outline (point) of a technique disclosed in JPA'447.

FIG. 16 is a view for explaining the rough outline (point) of a technique disclosed in JPA'257.

### DETAILED DESCRIPTION OF THE INVENTION

Hereinafter, embodiments of the invention will be specifically described with reference to the drawings.

### First Embodiment

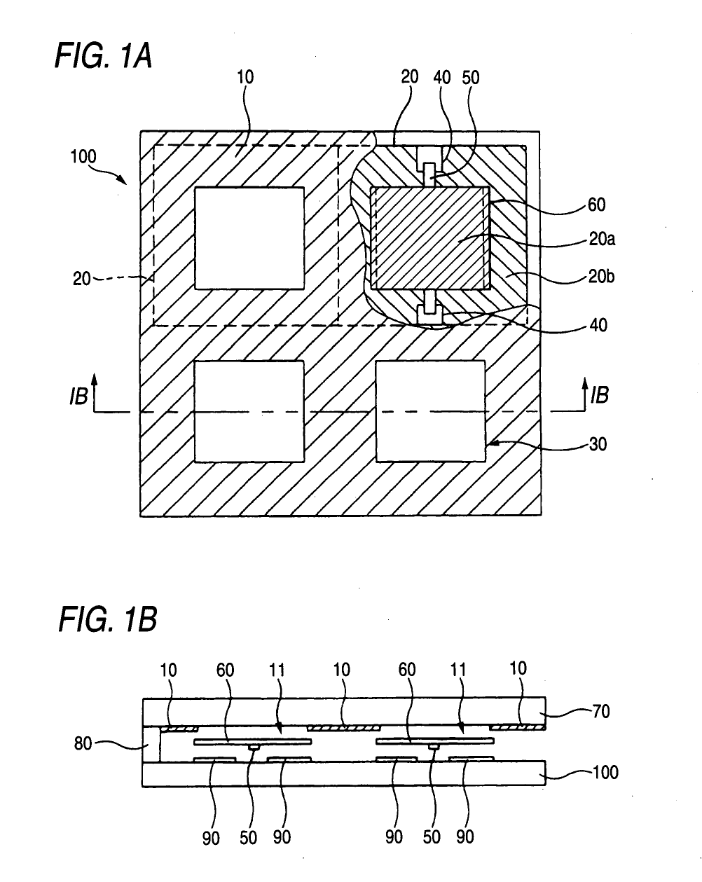

FIGS. 1A and 1B are views showing a layout structure of a main member of a reflection-type light modulation array device and a sectional structure thereof and for explaining a first embodiment. FIG. 1A is a layout view of a main member, and FIG. 1B is a sectional view taken along line IB-IB in FIG. 1A.

The reflection-type light modulation array device shown in FIGS. 1A and 1B, includes a silicon substrate 100 (hereinafter referred to as a substrate 100) on which a light modulation device 11 and its drive circuit (not shown) are formed, a transparent member 70 of glass or the like, and a support part 80 to support the transparent member 70 over the substrate 100. This reflection-type light modulation array device has a seal structure in which the substrate 100 and the transparent member 70 are disposed to be opposite to each other through the support part 80 while a specified interval is kept.

The plural light modulation devices 11 are arranged on the substrate 100 in a two-dimensional array form. The light modulation device 11 includes a pair of fixed electrodes 90 formed on the substrate 100, a pair of support parts 40 provided to stand on the substrate 100, a hinge 50 supported above the substrate 100 by the support parts 40, and a movable mirror 60 as a light reflecting member supported by the hinge 50 so as to be capable of being tilted with respect to the substrate 100. The pair of fixed electrodes 90 and the movable mirror 60 overlap with each other when viewed from a light source side (viewed on a plane: FIG. 1A).

The movable mirror 60 is tilted and displaced by electrostatic force between the movable mirror 60 and the fixed electrodes 90 caused by voltage application control of the drive circuit to the pair of fixed electrodes 90. The movable mirror 60 is tilted and displaced, so that it can have an ON state in which incident light is allowed to emerge to an image formation surface and an OFF state in which incident light is not allowed to emerge to the image formation surface. The image formation surface is a surface which is considered in the case where the reflection-type light modulation array device is used for an image forming apparatus, and is, for example, a recording material surface in the case where it is used for an exposure apparatus, and is a projection surface (screen) in the case where it is used for a projector. Besides, the ON state is a state in which the incident light is allowed to emerge to the image formation surface even if its amount is low, and the OFF state is a state in which the incident light is not allowed to emerge to the image formation surface. Hereinafter, a description will be made on the assumption that a state in which the movable mirror 60 is most rightward tilted with respect to the substrate 100 is the ON state, and a state in which the movable mirror 60 is parallel to the substrate 100 is the OFF state. Besides, in the case where the reflection-type light modulation array device of FIGS. 1A and 1B is mounted in an image forming apparatus, a description will be made on the assumption that in FIG. 1B, a light source is positioned just above the reflection-type light modulation array device.

In FIG. 1A, the four light modulation devices 11 in total form a two-dimensional matrix, and each of the light modulation devices 11 corresponds to one pixel. A square area drawn around the movable mirror 60 is a pixel area 20 corresponding to one pixel. The pixel area 20 includes an effective area 20a in which light modulation is performed and an ineffective area 20b in which light modulation is not performed.

The transparent member 70 includes, at a position on its surface at the side of the substrate 100 and opposite to an area of a gap between the effective areas 20a on the substrate 100 when viewed on a plane, a reflecting member 10 as a light-shielding unit to prevent the incident light from the light source from entering the substrate 100. As the reflecting member 10, for example, one of a metal mirror, a multi-layer interference mirror, and a diffraction grating can be used. Incidentally, even if the reflecting member 10 is not provided at the position opposite to the whole region of the gap between the effective areas 20a on the substrate 100 when viewed on a plane, the effect can be obtained. That is, when the reflecting member is provided at the position opposite to at least a part of the area of the gap between the effective areas 20a on the substrate 100 when viewed on a plane, light reaching the substrate 100 can be reduced.

In the case where the metal mirror is used as the reflecting member 10, there is a merit that the film formation and patterning are easy. In the case where the multi-layer interference film mirror is used as the reflecting member 10, there is a merit that absorption is low and there is little heat generation. In the case where the diffraction grating is used as the reflecting member 10, there is a merit that there is little heat generation, and the reflection direction of the light can be controlled.

As the light source, in the case where one emitting light with a wavelength of 450 nm or less, especially ultraviolet light is used, it is preferable that the mirror made of aluminum or aluminum alloy, or the multi-layer interference mirror is used as the reflecting member 10. This is because these mirrors can effectively reflect the incident light even if it is the ultraviolet light with a wavelength is 450 nm or less. In the case where the diffraction grating is used as the reflecting member 10, since light is not absorbed, there is a merit that heat generation at the reflecting member 10 is suppressed.

Incidentally, in FIG. 1A (when viewed on a plane), the reflecting member 10 overlaps with a part of the effective area 20a. In the reflection-type light modulation array device shown in FIG. 1A, in the case where the movable mirror 60 is most tilted with respect to the substrate 100, the effective area 20a when viewed on a plane becomes inside a dotted line in FIG. 1A, and becomes slightly smaller than that in the case where the movable mirror 60 is parallel to the substrate 100. Thus, when the reflecting member 10 is provided at the position opposite to the area of the gap between the effective areas 20a in the case where the movable mirror 60 is parallel to the substrate 100, in the case where the movable mirror 60 is most tilted with respect to the substrate 100, since the effective light area 20a becomes slightly narrow, all the incident light can not be reflected by the reflecting member 10, and part thereof enters the substrate 100. Then, in this embodiment, the effective area 20a on the substrate 100 when viewed on a plane is treated as the area inside the dotted line in FIG. 1A. That is, in the effective area 20a, an area outside the dotted line in FIG. 1A is treated as the ineffective area. However, even if such treatment is not performed, it is sufficiently possible to reduce the light entering the substrate 100.

As described above, the reflection-type light modulation array device of FIG. 1A has such a structure that when viewed on a plane, only the effective area 20a is exposed through a transparent window 30, and the other area is completely covered with the reflecting member 10.

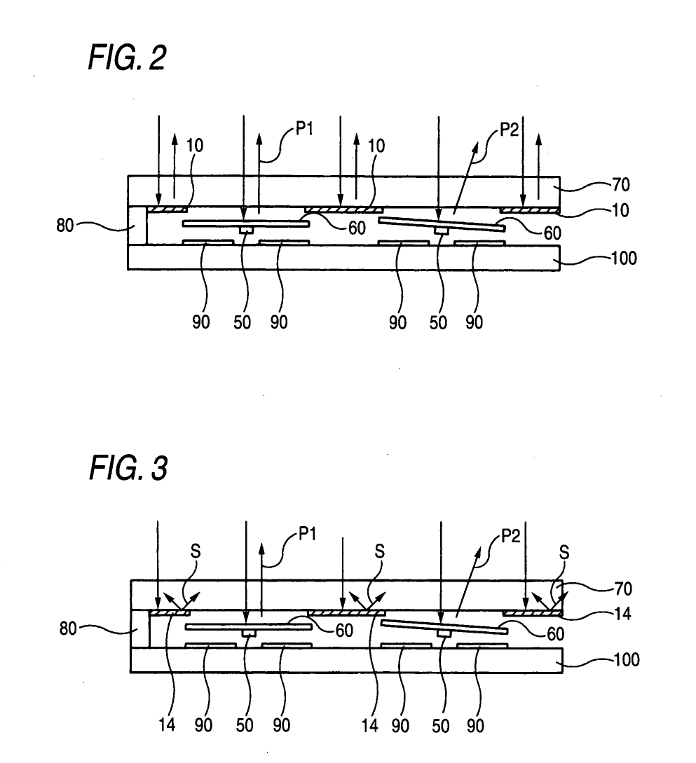

FIG. 2 is a sectional view for explaining the operation of the reflection-type light modulation array device of FIGS. 1A and 1B at the time of voltage application and at the time of no voltage application.

As shown on the left side of FIG. 2, in the case where voltage is not applied to the fixed electrodes 90, the movable mirror 60 becomes parallel to the surface of the substrate 100 (OFF state). Thus, the incident light from the light source is reflected vertically, and this light becomes an OFF light P1 which does not reach the image formation surface. Besides, as shown on the right side of FIG. 2, in the case where voltage is applied to the fixed electrodes 90, the movable mirror 60 is most rightward tilted (ON state). Thus, the incident light from the light source is reflected obliquely upward right, and this light becomes an ON light P2 which reaches the image formation surface. On the other hand, the incident light incident on an area other than the effective area 20a from the light source is vertically reflected by the reflecting member 10. Thus, the incident light from the light source does not enter the substrate 100, and further, the direction of the reflected light is the same as the OFF light P1, and the light does not reach the image formation surface.

As described above, according to the reflection-type light modulation array device of this embodiment, since the incident light from the light source, which becomes unnecessary for the light modulation, is reflected by the reflecting member 10, it is possible to prevent this incident light from entering the substrate 100. Thus, an erroneous operation, due to a photoelectric effect, of the drive circuit formed on the substrate 100, performance degradation caused by heat generation due to light absorption, and time degradation due to deposit adhesion by a photochemical reaction with the incident light are suppressed and the reliability is improved. Besides, the occurrence of stray light can be prevented, and the optical quality (contrast, etc.) of the system can be improved.

Besides, according to the reflection-type light modulation array device of this embodiment, since it is possible to prevent the incident light from entering the substrate 100, even in the case where the power of the incident light is large, heat generation of the substrate is suppressed, and the degradation of the device can be prevented, and accordingly, the reliability can be improved. Thus, large power light can be modulated, and the application to a high brightness projector display system or a high speed exposure system becomes possible. Especially, in the case where it is applied to the exposure system, near-UV exposure of an i-line or the like, or deep UV exposure of an emission wavelength of an excimer laser of ArF, KrF or the like becomes possible, and the exposure system with high speed, high resolution, and high reliability can be realized.

Besides, according to the reflection-type light modulation array device of this embodiment, the incident light from the light source is vertically reflected by the reflecting member 10, and the direction of the reflected light is coincident with the direction of the OFF light. Thus, only the ON light reaches the image formation surface, and the contrast of an image formed can be improved. In case a state where the movable mirror 60 becomes horizontal to the surface of the substrate 100 is the ON state, and a state where the movable mirror 60 is most rightward tilted is the OFF state, the light reflected by the reflecting member 10 also reaches the image formation surface, and the contrast of an image formed is reduced. However, according to this embodiment, such does not occur.

Besides, according to the reflection-type light modulation array device of this embodiment, since the reflecting member 10 is provided on the transparent member 70, not on the substrate 100 on which the light modulation device 11 is formed, the degree of freedom of the layout pattern of the reflecting member 10 becomes high, and it is also easy to enhance the light shielding effect. Besides, since the reflecting member 10 is provided on the transparent member 70, as compared with the case where the reflecting member 10 is provided on the substrate 100, the manufacturing process can be simplified. For example, manufacturing can be performed in such a simple procedure that after the transparent member 70 on which the reflecting members 10 are provided and the substrate 100 on which the light modulation devices 11 are provided are manufactured by different processes, both are bonded to each other. This manufacturing process will be described later.

Incidentally, in the example of FIGS. 1A, 1B and 2, although the reflecting member 10 is used as the light-shielding unit, instead of the reflecting member 10, an absorbing member to absorb the light, or a reflecting member to diffuse or scatter the light (hereinafter referred to as a light diffusing member) can also be used. The effect obtained in this case is the same as the foregoing. However, in the case where the absorbing member is used, since most of the incident light from the light source, which becomes unnecessary for light modulation, can be absorbed, there is no limitation as to the state of the movable mirror 60 which is made the ON state or the OFF state. As the light diffusing member, a light diffusing film or the like can be used.

Next, a description will be given to the case where the light diffusing film is used as the reflecting member 10. The light diffusing film is the film having a property to scatter the incident light. According to circumstances, a medium layer having a property to diffuse the light can also be used.

FIG. 3 is a sectional view showing an example in which the light diffusing film is used as the light-shielding unit in the reflection-type light modulation array device shown in FIGS. 1A, 1B and 2. The same components as those of FIGS. 1A, 1B and 2 are denoted by the same reference numerals. In the example shown in FIG. 3, a light diffusing film 14 is used as the light-shielding unit formed on the transparent member 70. In the drawing, reference character S denotes a diffused light.

In the case where the light diffusing film 14 is used, since incident light from a light source is diffused by the light diffusing film 14, it does not reach the substrate 100. Although part of the diffused light S comes to have the same direction as the ON light P2, since the incident light is diffused, the light is low. Accordingly, in the case where an image is formed based on the ON light P2, reduction in the contrast can be sufficiently prevented. Besides, there is a merit that since the light diffusing film 14 does not absorb the light, heat generation is suppressed. In the case where the light diffusing film 14 is used, similarly to the case where an absorbing member is used, there is no limitation as to the state of the movable mirror 60 which is made the ON state or the OFF state.

In FIGS. 1A and 1B, although the reflecting member 10 is provided on the surface of the transparent member 70 at the substrate 100 side, the invention is not limited to this.

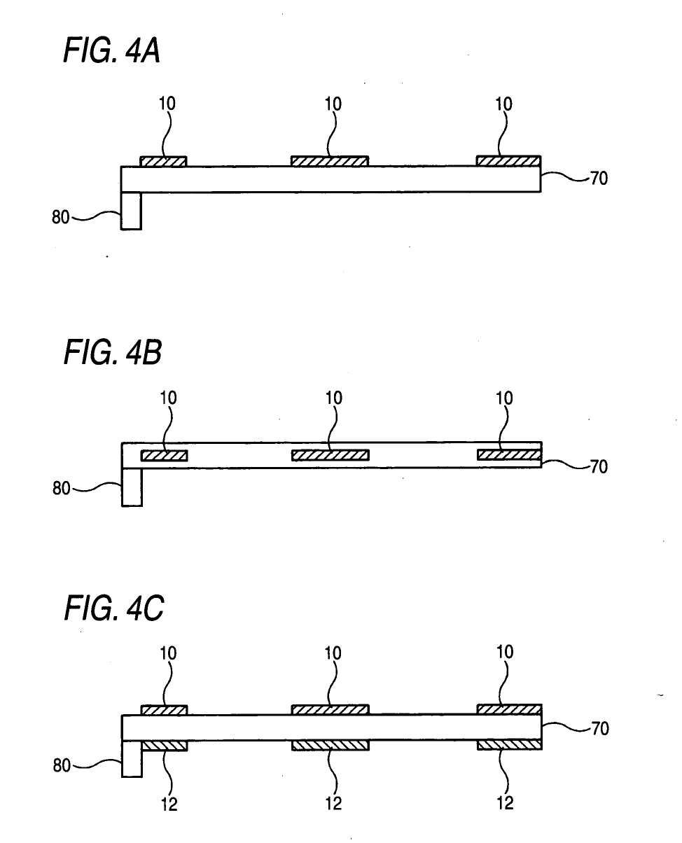

FIGS. 4A to 4C are sectional views showing other examples of the case where the transparent member 70 is provided with the reflecting member 10. The same components as FIG. 2 are denoted by the same reference numerals.

For example, as shown in FIG. 4A, a structure may be made such that the reflecting member 10 is provided on a surface (surface at the side where the incident light from the light source is incident) of the transparent member 70 opposite to a surface thereof at the substrate 100 side. In this case, although the light shielding capacity to the obliquely incident light is slightly inferior to the example of FIGS. 1A, 1B and 2, since the reflecting member 10 is positioned outside a sealing body, the influence of heat generation of the reflecting member 10 itself on the substrate 100 can be made smaller than the case of FIGS. 1A, 1B and 2.

Besides, as shown in FIG. 4B, a structure may be made such that the reflecting member 10 is provided in the inside of the transparent member 70. This structure can be realized by adopting, for example, a method of bonding two transparent members to form one transparent member 70. In this case, the light shielding capacity to the obliquely incident light is slightly inferior to the example of FIGS. 1A, 1B and 2, the light shielding capacity is higher than the case of FIG. 4A. Besides, since the reflecting member 10 is in the inside of the transparent member 70, the influence of heat generation of the reflecting member 10 itself on the substrate 100 can be made smaller than the case of FIGS. 1A, 1B and 2.

Besides, as shown in FIG. 4C, a structure may be made such that the reflecting member 10 is provided at a surface of the transparent member 70 at the substrate 100 side and an opposite surface thereof. In this case, the light shielding effect can be further raised. Besides, films having different properties can be suitably combined and used, for example, the light reflecting member is provided on the surface of the transparent member 70 at the substrate 100 side, and the absorbing member is provided at the opposite surface thereof. By this, under various conditions, the optimum light shielding effect can be realized.

Incidentally, the variation of the formation position of the light-shielding unit shown in FIGS. 4A to 4C can be similarly adopted in following embodiments, and the same effect can be obtained.

### Second Embodiment

A feature of a reflection-type light modulation array device of this embodiment is that instead of the light modulation device 11 described in the first embodiment, a light modulation device including plural light reflecting members each being capable of being vertically displaced with respect to a substrate (a device which includes plural movable mirrors as light reflecting members, and in which positions of the adjacent movable mirrors are made different from each other, and the diffraction of light is used to control the direction of the reflected, for example, a GLV) is used.

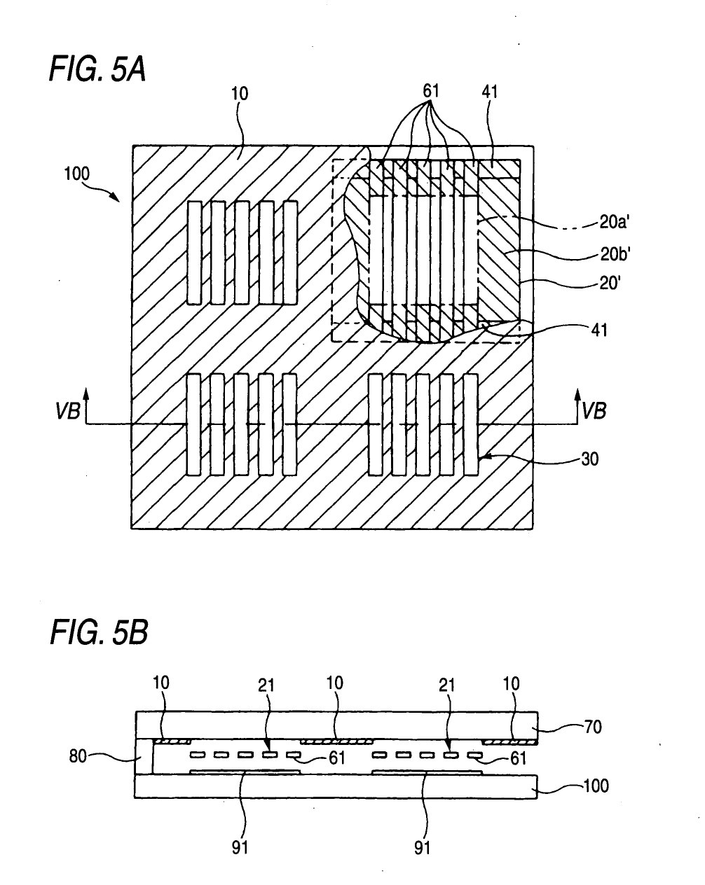

FIGS. 5A and 5B are views showing a layout structure of a main member of a reflection-type light modulation array device and a sectional structure thereof and for explaining a second embodiment of the invention. FIG. 5A is a layout view of the main member, and FIG. 5B is a sectional view taken along line VB-VB in FIG. 5A. In FIGS. 5A and 5B, the same components as FIGS. 1A, 1B and 2 are denoted by the same reference numerals.

The total structure of the reflection-type light modulation array device of FIGS. 5A and 5B is substantially equal to the reflection-type light modulation array device of the former embodiment. However, as set forth above, the only difference is such that in the example of FIGS. 5A and 5B, instead of the light modulation device 11, a light modulation device 21 including plural movable mirrors 61 which are light reflecting members and can be displaced, is used.

The light modulation device 21 includes a fixed electrode 91 formed on a substrate 100, a pair of support parts 41 provided on the substrate 100, and plural movable mirrors 61 supported above the substrate 100 by the support parts 41 so as to be capable of being vertically displaced. The fixed electrode 91 and part of the respective movable mirrors 61 overlap with each other when viewed on a plane.

By voltage application control of a drive circuit to the fixed electrode 91, and by electrostatic force between the respective movable mirrors 61 and the fixed electrode 91, the plural movable mirrors 61 are alternately vertically displaced (normally, displaced by a distance corresponding to λ/4), so that the plural movable mirrors 61 can have an ON state where incident light is allowed to emerge to an image formation surface and an OFF state where incident light is not allowed to emerge to the image formation surface. Hereinafter, a description will be made on the assumption that a state (at the time of no voltage application) where the respective movable mirrors 61 are arranged on one line in a direction parallel to the substrate 100 is the OFF state, and a state where the respective movable mirrors 61 are alternately vertically displaced is the ON state. Incidentally, as the light modulation device 21, a well-known one can be used.

In FIGS. 5A and 5B, the four light modulation devices 21 in total form a two-dimensional matrix, and each of the light modulation devices 21 corresponds to one pixel. A square area drawn around the movable mirror 61 is a pixel area 20′ corresponding to one pixel. The pixel area 20′ includes an effective area 20a′ where light modulation is performed and an ineffective area 20b′ where light modulation is not performed. In the case of FIGS. 5A and 5B, differently from the case of FIGS. 1A and 1B, the effective area 20a′ when viewed on a plane is an area where the fixed electrode 92 and the respective movable mirrors 61 overlap with each other.

Similarly to the first embodiment, a transparent member 70 includes, at a position on a surface thereof opposite to an area of a gap between the effective areas 20a′ on the substrate 100 when viewed on a plane, a reflecting member 10 as a light-shielding a unit to prevent incident light from a light source from entering the substrate 100.

As described above, the reflection-type light modulation array device of FIG. 5A has such structure that when viewed on a plane, only the effective area 20a′ is exposed from a transparent window 30, and other areas are completely covered with the reflecting member 10.

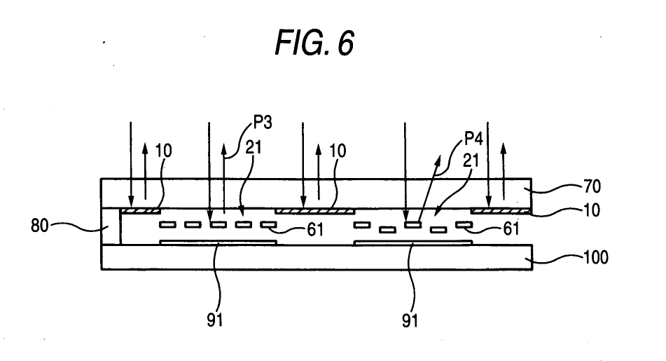

FIG. 6 is a sectional view for explaining the operation of the reflection-type light modulation array device of FIGS. 5A and 5B at the time of voltage application and at the time of no voltage application.

As shown on the left of FIG. 6, in the case where voltage is not applied, the movable mirrors 61 are in the state (OFF state) where they are arranged linearly in the direction parallel to the substrate 100. Thus, since the incident light from the light source is vertically reflected, the reflected light becomes an OFF light P3 which does not reach the image formation surface. Besides, as shown on the right of FIG. 6, in the case where voltage is applied to the fixed electrode 91, the respective movable mirrors 61 are in the state where they are alternately vertically displaced (ON state). Thus, since the incident light from light source is reflected obliquely upward right, the reflected light becomes an ON light P4 which reaches the image formation surface. On the other hand, incident light coming from the light source and incident on an area other than the effective area 20a′ is vertically reflected by the reflecting member 10. Thus, the reflected light does not reach the image formation surface. Besides, the incident light from the light source does not enter the substrate 100.

As described above, according to the reflection-type light modulation array device of this embodiment, the same effect as the first embodiment can be obtained.

Incidentally, in this embodiment, in the case where the reflecting member 10 is used as the light-shielding unit, similarly to the first embodiment, it is important that the reflection direction of the incident light from the light source when the plural movable mirrors 61 are in the OFF state is made coincident with the reflection direction of the incident light from the light source by the reflecting member 10.

### Third Embodiment

A feature of a reflection-type light modulation array device of this embodiment is that instead of the light modulation device 11 described in the first embodiment, a light modulation device including a light reflecting member being capable of being vertically displaced with respect to a substrate (a device in which a movable mirror as a light reflecting member is vertically displaced to change the phase of reflected light and to perform light modulation) is used, and an absorbing member is used as a light-shielding unit.

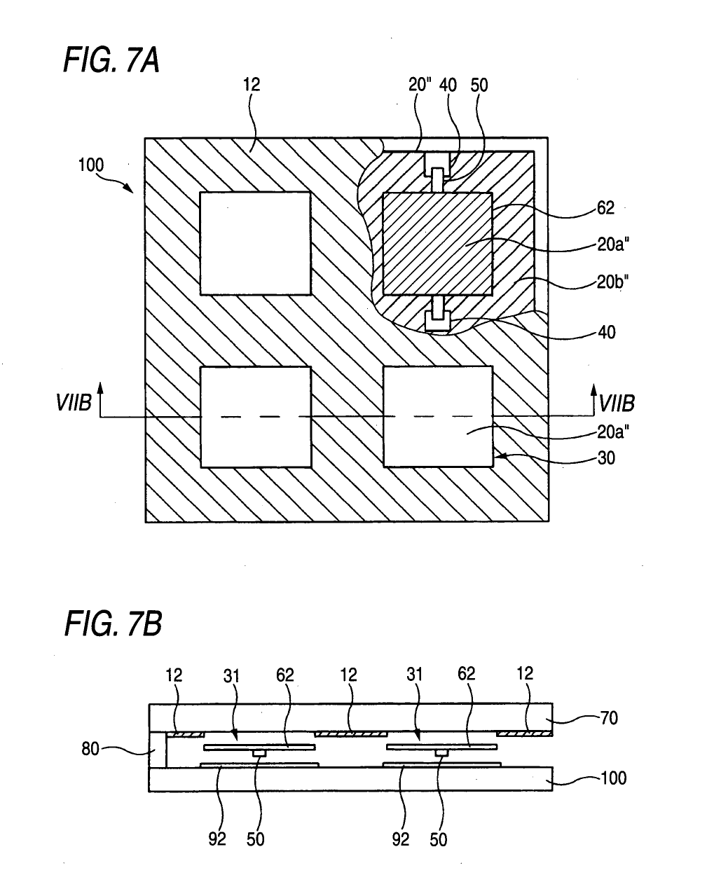

FIGS. 7A and 7B are views showing a layout structure of a main member of a reflection-type light modulation array device and a sectional structure thereof and for explaining a third embodiment of the invention. FIG. 7A is a layout view of the main member, and FIG. 7B is a sectional view taken along line VIIB-VIIB. In FIGS. 7A and 7B, the same components as FIGS. 1A, 1B and 2 are denoted by the same reference numerals.

The total structure of the reflection-type light modulation array device of FIGS. 7A and 7B is substantially equal to the reflection-type light modulation array device of the first embodiment. However, as stated above, the case of FIGS. 7A and 7B is different only in that instead of the light modulation device 11, a light modulation device 31 including a movable mirror 62 which is the light reflecting member and can be vertically displaced is used, and a light absorbing film 12 as an absorbing member is used as a light-shielding unit.

The light modulation device 31 includes a fixed electrode 92 formed on a substrate 100, a pair of support parts 40 provided to stand on the substrate 100, a hinge 50 supported on the substrate 100 by the support parts 40, and a movable mirror 62 as a light reflecting member supported by the hinge 50 so as to be capable of being vertically displaced with respect to the substrate 100. The fixed electrode 92 and the movable mirror 62 overlap with each other when viewed on a plane.

The movable mirror 62 is vertically displaced by voltage application control of a drive circuit to the fixed electrode 92 and by electrostatic force between the movable mirror 62 and the fixed electrode 92. The movable mirror 62 is vertically displaced so that it can have an ON state where incident light is allowed to emerge to an image formation surface and an OFF state where incident light is not allowed to emerge to the image formation surface. Hereinafter, a description will be given on the assumption that a state where the movable mirror 62 is located at a position nearest to the substrate 100 is the ON state and a state where the movable mirror 62 is located at a position farthest from the substrate 100 is the ON state. Incidentally, as the light modulation device 31, a well-known one can be used.

Besides, in the light modulation device 31, differently from the light modulation device 11, since the direction of an ON light and the direction of an OFF light are coincident with each other, when a reflecting member is used as the light-shielding unit, the reflected light by the light-shielding unit and the ON light can not be distinguished from each other. Thus, in this embodiment, the light absorbing film 12 is used as the light-shielding unit.

In FIGS. 7A and 7B, the four light modulation devices 31 in total form a two-dimensional matrix, and each of the light modulation devices 31 corresponds to one pixel. A square area drawn around the movable mirror 62 is a pixel area 20″ corresponding to one pixel. The pixel area 20″ includes an effective area 20a″ where light modulation is performed and an ineffective area 20b″ where light modulation is not performed. In the case of FIGS. 7A and 7B, differently from the case of FIGS. 1A and 1B, the effective area 20a″ when viewed on a plane is the same as the area of the movable mirror 62.

Similarly to the first embodiment, a transparent member 70 includes, at a position on a surface thereof at a side of the substrate 100 and opposite to an area of a gap between the effective areas 20a″ on the substrate 100 when viewed on a plane, the light absorbing film 12 as the light-shielding unit to prevent incident light from a light source from entering the substrate 100. However, in the case of FIGS. 7A and 7B, differently from the case of FIGS. 1A and 1B, since the effective area 20a″ when viewed on a plane is equal to the area of the movable mirror 62 when viewed on a plane, the light absorbing film 12 and the movable mirror 62 do not overlap with each other when viewed on a plane.

As described above, the reflection-type light modulation array device of FIGS. 7A and 7B has such structure that when viewed on a plane, only the effective area 20a″ is exposed from a transparent window 30, and other areas are completely covered with the light absorbing film 12.

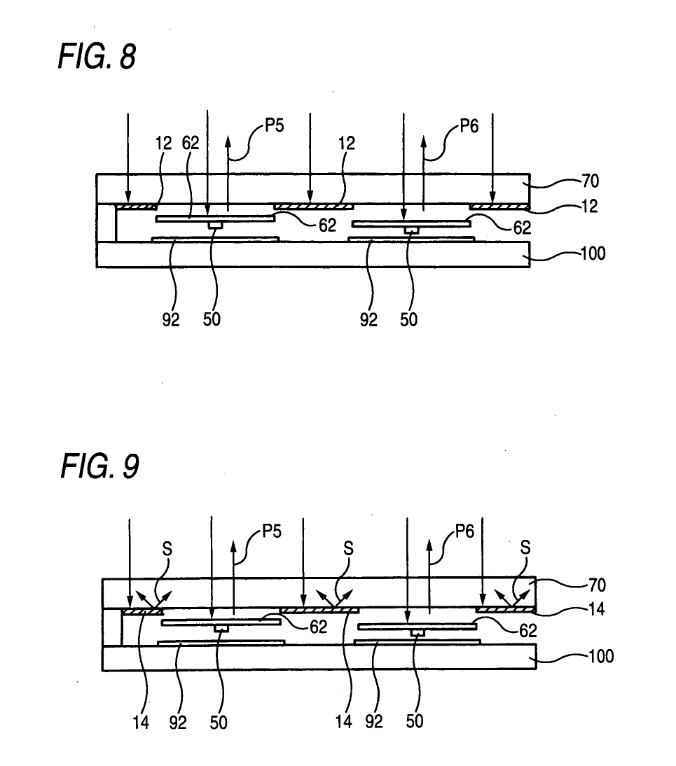

FIG. 8 is a sectional view for explaining the operation of the reflection-type light modulation array device of FIGS. 7A and 7B at the time of voltage application and at the time of no voltage application.

As shown on the left of FIG. 8, in the case where voltage is not applied to the fixed electrode 92, the movable mirror 62 is put in a state (OFF state) where it is most remote from the substrate 100. Thus, although incident light from a light source is vertically reflected, since the phase of the reflected light is not changed, it becomes an OFF light P5 which does not reach an image formation surface. Besides, as shown on the right of FIG. 8, in the case where voltage is applied to the fixed electrode 92, the movable mirror 62 is put in a state (ON state) where it is nearest to the substrate 100. Thus, although incident light from the light source is vertically reflected, since the phase of the reflected light is changed, it becomes an ON light P6 which reaches the image formation surface. On the other hand, incident light from the light source incident on an area other than the effective area 20a′ is absorbed by the light absorbing film 12. Thus, the incident light from the light source does not enter the substrate 100.

As described above, according to the reflection-type light modulation array device of this embodiment, in the case of using the light modulation device in which the light reflecting member is vertically displaced so that light modulation is performed, by using the light absorbing film as the light-shielding unit, the contrast of an image formed is not reduced, and it is possible to prevent the incident light from the light source from entering the substrate 100.

Incidentally, in the example of FIGS. 7A, 7B and 8, although the light absorbing film 12 is used as the light-shielding unit, instead of the light absorbing film 12, a light diffusing member to diffuse or scatter the light can also be used. The effect obtained in this case is the same as the foregoing. As the light diffusing member, a light diffusing film or the like can be used.

Hereinafter, a description will be given to a case where a light diffusing film is used instead of the light absorbing film 12. According to circumstances, a medium layer having a property to diffuse light can also be used.

FIG. 9 is a sectional view showing an example in which the light diffusing film is used as the light-shielding unit in the reflection-type light modulation array device shown in FIGS. 7A, 7B and 8. The same components as those of FIGS. 7A, 7B and 8 are denoted by the same reference numerals. In the example shown in FIG. 9, a light diffusing film 14 is used as the light-shielding unit formed on the transparent member 70. In the drawing, reference character S denotes a diffused light.

In the case where the light diffusing film 14 is used, since incident light from a light source is diffused by the light diffusing film 14, it does not reach the substrate 100. Although there is a case where part of the diffused light S comes to have the same direction as the ON light P6, since the incident light is diffused, the light is low. Accordingly, in the case where an image is formed based on the ON light P6, reduction in the contrast can be sufficiently prevented. Besides, there is also a merit that since the light diffusing film 14 does not absorb light, heat generation is suppressed.

### Fourth Embodiment

In this embodiment, with respect to manufacturing processes of the reflection-type light modulation array devices described in the first to the third embodiments, a description will be made while the reflection-type light modulation array device shown in FIGS. 1A and 1B is used as an example. Since the manufacturing processes of the reflection-type light modulation array devices of FIGS. 5A, 5B, 7A and 7B are different only in the manufacturing process of the light modulation device, their description will be omitted.

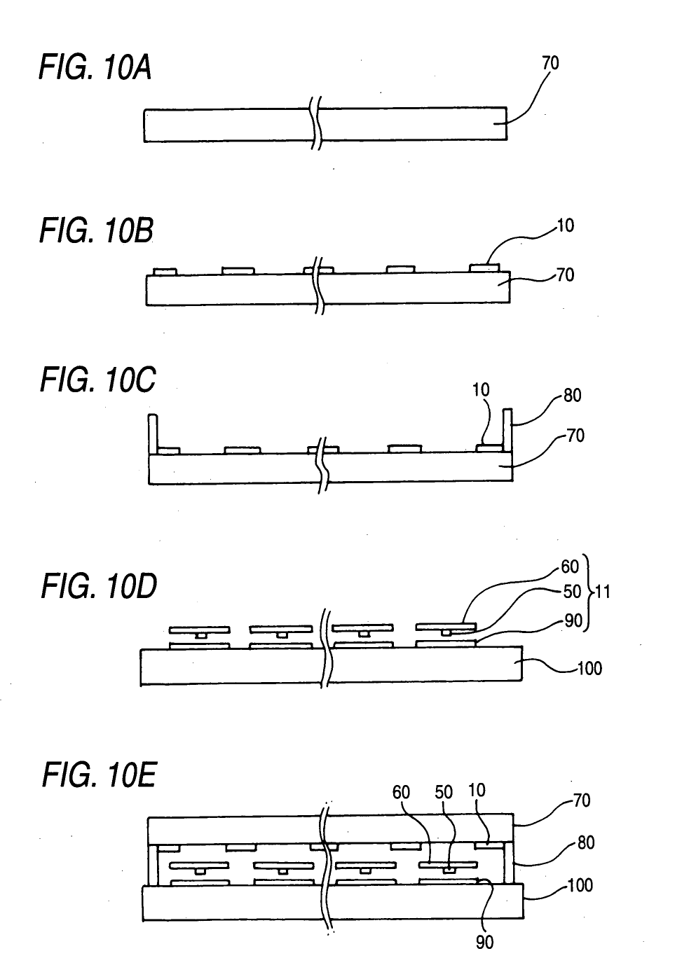

FIGS. 10A to 10E are views for explaining main manufacturing steps of the reflection-type light modulation array device shown in FIGS. 1A and 1B, and are sectional views at the respective steps.

First, as shown in FIG. 10A, a transparent member 70 is prepared. As the transparent member 70, it is desirable to use glass whose thermal expansion coefficient is close to a silicon substrate 100.

Next, as shown in FIG. 10B, a reflecting member 10 with a desired pattern is formed on the surface of the transparent member 70. Specifically, the reflecting member 10 is one of a metal mirror, a multi-layer interference mirror, and a diffraction grating. Instead of the reflecting member 10, a light absorbing film such as an AR film, or a light diffusing film may be formed. The reflecting member 10 is formed through a film formation step, a photolithography step, and patterning by etching. Besides, at the time of formation of the reflecting member 10, an alignment pattern (not shown) for alignment used at an after-mentioned bonding step is also simultaneously formed.

Next, as shown in FIG. 10C, on the periphery of the transparent member 70, a support (support part: spacer) 80 is formed in a form of surrounding the reflection-type light modulation array device in the case where the transparent member 70 and a substrate 100 are bonded to each other. At the formation of the support 80, there is used an adjusted solution in which a spacer particle (resin or silica) to determine the height of the support 80 is dispersed in a UV curing or thermosetting adhesive. That is, this adjusted solution is pattern-applied by a dispense method, a screen printing method or the like. Besides, as another method, there is a method in which the support 80 is constructed of metal, glass material, resin or the like. In this case, the support 80 is formed through a film formation step, a photolithography step, and an etching step. According to the photolithography method, formation with high accuracy is possible. The height of the support 80 is selected such that the operation of the light modulation device is not prevented and the height is as low as possible. Specifically, it is preferable that the height is approximately 2 μm to 20 μm. Incidentally, as the support 80, a metal bonding material such as a solder bump can also be used. After the formation of the support 80, an adhesive is applied to the tip portion of the support.

On the other hand, by a quite different step from FIGS. 10A to 10C, as shown in FIG. 10D, plural light modulation devices 11 are formed into an array on the silicon substrate 100. Besides, at this time, an alignment pattern (not shown) for alignment used at the next bonding step is also simultaneously formed.

Then, as shown in FIG. 10E, the transparent member 70 is disposed over the silicon substrate 100 on which the plural light modulation devices 11 are formed (at this time, the reflecting members 10 and the support 80 formed on the transparent member 70 are made to face the silicon substrate 100), and then, alignment is performed using the alignment patterns respectively formed on the substrate 100 and the transparent member 70, and the substrate 100 and the transparent member 70 are bonded to each other while pressing is performed, and according to the kind of the adhesive used, ultraviolet irradiation or heating is performed to harden the adhesive. By the above steps, the reflection-type light modulation array device shown in FIGS. 1A and 1B is manufactured.

According to this method, since the transparent member 70 on which the reflecting members 10 are formed and the substrate 100 on which the light modulation devices 11 are formed can be manufactured by the different steps, the manufacturing step of the substrate 100 is not complicated, and the degree of freedom of design of each of the transparent member 70 and the substrate 100 can also be kept. Besides, after the transparent member 70 and the substrate 100 are manufactured, since the transparent member 70 and the substrate 100 have only to be bonded to each other, the manufacturing is easy. Besides, since the alignment using the alignment patterns is performed, high accuracy bonding is possible.

Accordingly, by using this manufacturing method, a countermeasure against unnecessary light or a countermeasure against stray light can be effectively performed without complicating the manufacturing process of the reflection-type light modulation array device, an increase in temperature of the silicon substrate can be effectively prevented, and a reduction in reliability of the light modulation device and a drive system device can also be prevented.

### Fifth Embodiment

In this embodiment, a description will be given to an image forming apparatus in which the reflection-type light modulation array device described in the first to the third embodiments is mounted.

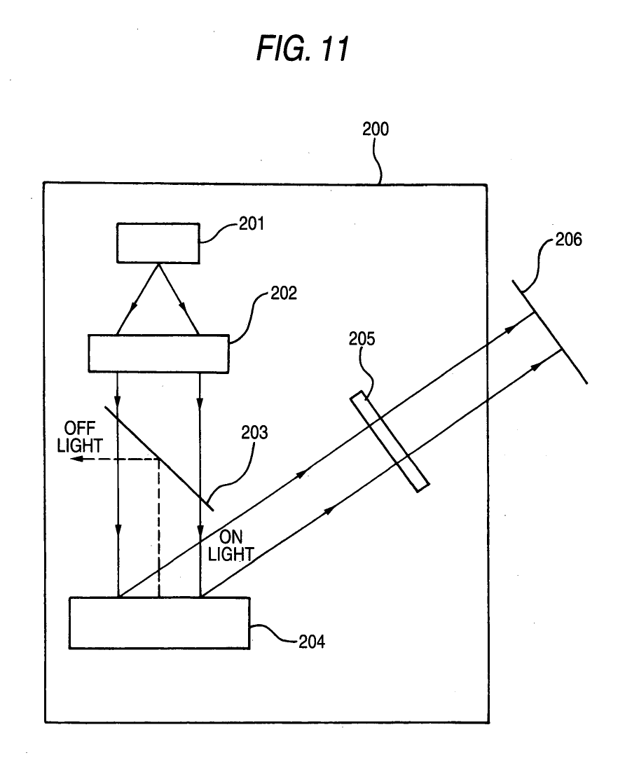

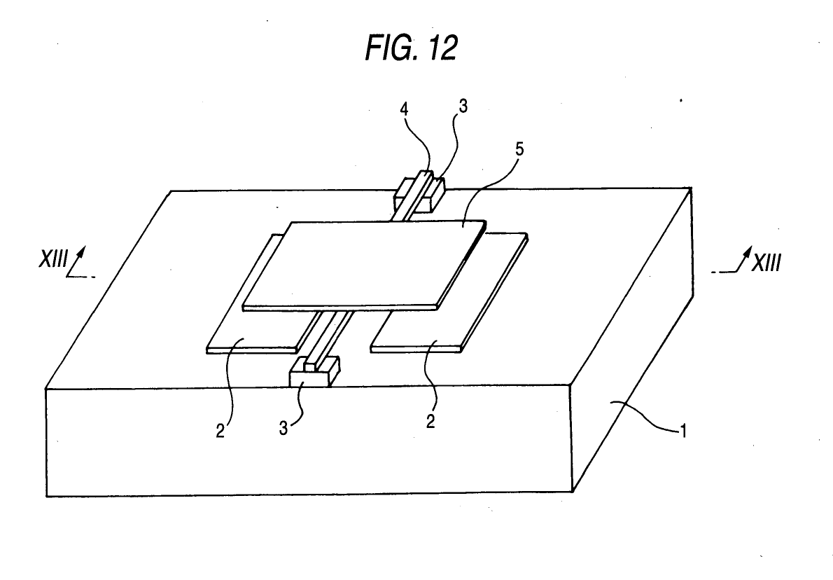

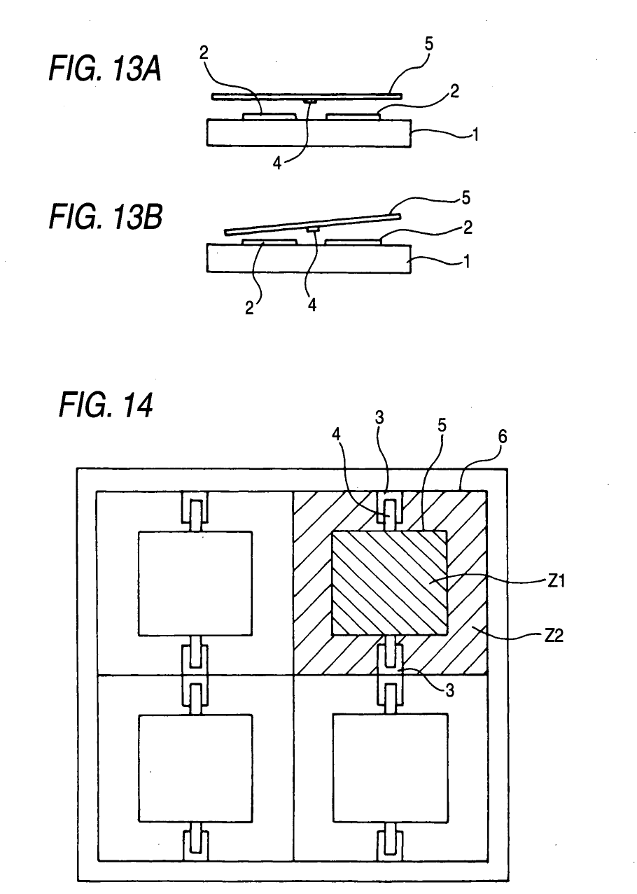

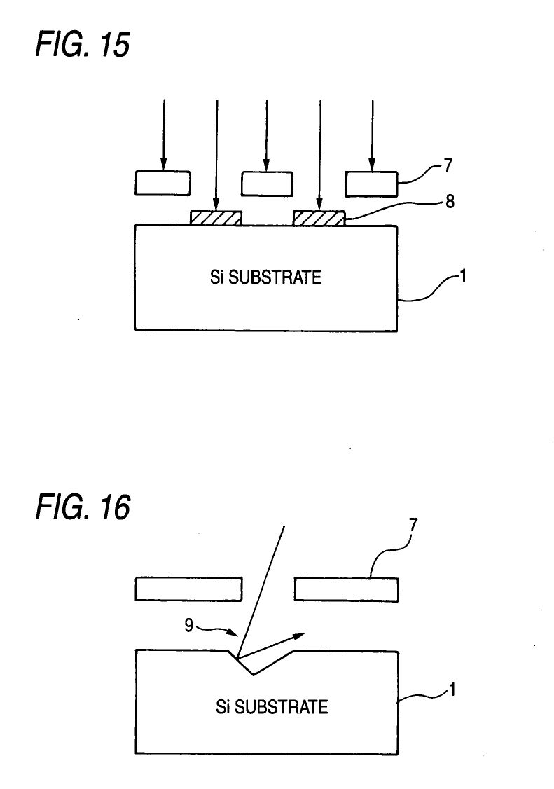

FIG. 11 is a view showing a main structure of an example (exposure apparatus) of an image forming apparatus in which the reflection-type light modulation array device described in the first to the third embodiments is mounted.

An exposure apparatus 200 includes an illumination light source 201, an illumination optical system 202, a half mirror 203, a reflection-type light modulation array device (here, which is one shown in FIGS. 1A, 1B and 2) 204 described in the first to the third embodiments, and a projection optical system 205. Reference numeral 206 denotes an image formation surface of an image recording material.

The illumination light source 201 is a light source such as a laser, a high-pressure mercury vapor lamp, or a short arc lamp. As the light source, one emitting ultraviolet light with a wavelength of 450 nm or less can also be used.

The illumination optical system 202 is a collimate lens to convert, for example, a planar light emitted from the illumination light source 201 into a parallel light. The parallel light transmitted through the collimate lens passes through the half mirror 203, and is vertically incident on effective areas of respective light modulation devices of the reflection-type light modulation array device 204.

As means for converting the planar light emitted from the illumination light source 201 into the parallel light, in addition to the collimate lens, there is a method in which two microlenses are arranged in series. Besides, as the illumination light source 201, one having a small light emitting point, such as a short arc lamp, may be used, so that the illumination light source 201 is regarded as a point light source, and the parallel light is incident on the reflection-type light modulation array device 204. Besides, as the illumination light source 201, an LED array having LEDs corresponding to the respective light modulation devices of the reflection-type light modulation array device 204 may be used, so that the LED array and the reflection-type light modulation array device 204 are made close to each other to emit light, and the parallel light is incident on the respective light modulation devices of the reflection-type light modulation array device 204. In the case where a laser is used as the illumination light source 201, the illumination optical system 202 may be omitted.

The projection optical system 205 is a projection lens group for performing projection and exposure of light on the image formation surface 206.

Hereinafter, the operation of the exposure apparatus 200 will be described.

The planar light emitted from the illumination light source 201 is incident on the illumination optical system 202, and the light converted into the parallel light here passes through the half mirror 203 and is incident on the reflection-type light modulation array device 204. The light incident on the reflection-type light modulation array device 204 is reflected according to an image signal, the OFF light is reflected by the half mirror 203 in a direction different from the light source 201, and only the ON light is incident on the projection optical system 205 and is projected and exposed on the image formation surface 206. The projection light is projected and exposed on the image formation surface 206 while relatively moving in the scanning direction, and a wide area can be exposed to the light at high resolution.

When the reflection-type light modulation array device described in the embodiment is used for, as the image forming apparatus, a projector or a display device in addition to the exposure apparatus, a high contrast image can be formed.

Incidentally, in the first and the second embodiments, as the specific example of the reflection-type light modulation array device, one in which the direction of the reflected light by the light reflecting member is controlled to perform modulation (for example, DMD or GLV) has been mentioned. However, in addition to this, the same effect can be obtained even in the case of using one in which the interference of reflected light by the light reflecting member is controlled to perform modulation, or one disclosed in patent document 2.

Besides, in the first to the third embodiments, as the reflection-type light modulation array device, one in which the light modulation devices are arranged two-dimensionally is used as the example, and the description has been made. However, the invention is not limited to this, and even when the light modulation devices are linearly arranged, the same effect can be obtained.

What is claimed is:

1. A reflection-type light modulation array device, comprising:
a plurality of light modulation devices arranged in a array form, each of which includes a displaceable light reflecting member capable of having an ON state in which incident light is allowed to emerge to an image formation surface and an OFF state in which incident light is not allowed to emerge to the image formation surface, and light modulation is performed by individually controlling displacements of the light reflecting members;
a substrate on which the plurality of light modulation devices are arranged in an array form; and
a transparent member arranged to be opposite to the substrate through a gap,
wherein the transparent member comprises, at a position opposite to at least a part of an area of a gap between effective areas where the light modulation is performed on the substrate when viewed on a plane, a light shielding unit to prevent the incident light from entering the substrate.

2. The reflection-type light modulation array device according to claim 1, wherein the light-shielding unit is provided at the position on a surface of the transparent member at a side of the substrate.

3. The reflection-type light modulation array device according to claim 1, wherein the light-shielding unit is provided at the position on a surface opposite to a surface of the transparent member at a side of the substrate or in an inside of the transparent member.

4. The reflection-type light modulation array device according to claim 1, wherein the light-shielding unit is provided at the position on a surface of the transparent member at a side of the substrate and an opposite surface thereof.

5. The reflection-type light modulation array device according to claim 1, wherein the light modulation device changes a reflection direction of the incident light by the light reflecting member so that the light modulation device has the ON state and the OFF state.

6. The reflection-type light modulation array device according to claim 5, wherein
the light modulation device comprises a hinge part which supports the light reflecting member and is capable of tilting and displacing the light reflecting member with respect to the substrate, and a support part to support the hinge part on the substrate, and
a reflection direction of the incident light is changed by tilting and displacing the light reflecting member by electrostatic force.

7. The reflection-type light modulation array device according to claim 1, wherein the light-shielding unit is a reflecting member to reflect the incident light.

8. The reflection-type light modulation array device according to claim 5, wherein the light-shielding unit is a reflecting member to reflect the incident light.

9. The reflection-type light modulation array device according to claim 8, wherein a reflection direction of the incident light reflected by the reflecting member is equal to part of the reflection direction of the incident light when the light reflecting member has the OFF state.

10. The reflection-type light modulation array device according to claim 7, wherein the reflecting member comprises one of a metal mirror, a multi-layer interference mirror, and a diffraction grating.

11. The reflection-type light modulation array device according to claim 7, wherein
the incident light is a light with a wavelength of 450 nm or less, and
the reflecting member is one of a mirror made of aluminum or aluminum alloy and a multi-layer interference mirror.

12. The reflection-type light modulation array device according to claim 1, wherein the light-shielding unit is a light reflecting member to diffuse or scatter the incident light.

13. The reflection-type light modulation array device according to claim 1, wherein the light-shielding unit is an absorbing member to absorb the incident light.

14. The reflection-type light modulation array device according to claim 1, wherein
the light modulation device comprises a hinge part which supports the light reflecting member and is capable of vertically displacing the light reflecting member with respect to the substrate, and a support part to support the hinge part on the substrate, and
the light reflecting member is vertically displaced to change a phase of the incident light reflected by the light reflecting member so that the light reflecting member has one of the ON state and the OFF state.

15. The reflection-type light modulation array device according to claim 14, wherein the light-shielding unit is an absorbing member to absorb the incident light.

16. The reflection-type light modulation array device according to claim 14, wherein the light-shielding unit is a reflecting member to diffuse or scatter the incident light.

17. The reflection-type light modulation array device according to claim 1, further comprising a support part to support the transparent member on the substrate.

18. An image forming apparatus comprising:
a reflection-type light modulation array device according to claim 1;
a light source to make the incident light incident on the reflection-type light modulation array device; and
a projection optical system to project light emerging from the reflection-type light modulation array device in the ON state onto an image formation surface.
